(19) United States
(12) Patent Application Publication
(10) Pub. No.: US 2008/0232889 A1
(43) Pub. Date: Sep. 25, 2008

(54) Ink ribbon cassette and printing apparatus

(75) Inventor: Haruo Sato, Fukushima-ken (JP)

Correspondence Address: RABIN & Berdo, PC, 1101 14TH STREET, NW, SUITE 500, WASHINGTON, DC, 20005, US

(73) Assignee: OKI DATA CORPORATION, Tokyo (JP)

(21) Appl. No.: 12/071,972

(22) Filed: Feb. 28, 2008

(30) Foreign Application Priority Data
Mar. 19, 2007 (JP) 2007-071163

(51) Int. Cl. B41J 33/00

(52) U.S. Cl. 400/223

(57) ABSTRACT

An ink ribbon cassette which is used in printing apparatus and is able to prevent the ink ribbon from getting across the lengthways embankment to cause dual movement even if in the case that the ink ribbon is extended for prolong the life of the ink ribbon cassette. In the ink ribbon cassette, a lengthways embankment is furnished near to an ejecting opening of ink ribbon cassette in ink ribbon lodging section, that makes an interval the ink ribbon 3 passes becomes narrow and uniformly extends to an embankment of upper cover from an embankment of lower cover; or dual embankments are furnished on ink ribbon movement path at the downstream side of ink ribbon lodging section, that respectively protrudes from upper cover and lower cover; or protruding portions are respectively furnished near to entering opening and ejecting opening of ink ribbon lodging section.

### BACKGROUND OF THE INVENTION

1. Field of the Invention

The invention relates to an ink ribbon cassette to lodge ink ribbon and relates to a printing apparatus.

2. Related Background Art

Initially, it is to explain a conventional ink ribbon cassette by using FIG. 16. FIG. 16 is a diagram showing a structure of a conventional ink ribbon cassette.

As shown by FIG. 16, in an ink ribbon cassette 1, an ink ribbon 3 is sandwiched and is taken into an ink ribbon lodging section 6 by rotation of a drive gear 10 and a transfer gear 7; the ink ribbon 3, while guided by an embankment 4a formed on lower cover 12 and an embankment 4b that will be mentioned below, is drawn out from the ink ribbon lodging section 6 as a strip of ink ribbon.

FIG. 17 is a longitudinal section diagram showing a conventional embankment part.

As shown by FIG. 17, the embankment 4a is formed on the lower cover 12 and the embankment 4b is formed on an upper cover 11. Then, because the ink ribbon 3 is drawn out by a control from two sides (i.e. along a vertical direction in FIG. 17) through the embankment 4a and the embankment 4b, so the ink ribbon 3 dose not overlap and does not dash out. (e.g. refer to patent document 1).

Patent document 1: Japan utility model publication H05-035327.

However, in order to prolong the life of the ink ribbon cassette 1, it is necessary to extend the length of the ink ribbon 3.

FIG. 18 is a diagram showing operation of a conventional ink ribbon cassette. As shown by FIG. 18, in the case to extend the length of the ink ribbon 3, such state happened, that is, the ink ribbon 3 can not be arranged to be lodged, then the ink ribbon 3 falls into disorder as shown by a broken line part H, and the back part of the ink ribbon 3 outstrips the front part of the ink ribbon 3 as shown by a broken line part F2.

In such state, there is the following problem. That is, in the conventional ink ribbon cassette 1, though the ink ribbon 3 does not dashes out by the embankment 4a and the embankment 4b, the front and the back parts of the ink ribbon 3 are synchronously drawn out because of a friction caused when the ink ribbon 3 is drawn out, then the ink ribbon 3 gets across the embankment 4a and the embankment 4b as shown by a broken line part G2, the ink ribbon 3 happens a dual movement so that a ribbon jam happened.

### SUMMARY OF THE INVENTION

It is, therefore, an object of the invention to provide an ink ribbon cassette and a printing apparatus capable of solving the above problem.

According to the present invention, there is provided An ink ribbon cassette, comprising an ink ribbon lodging section that has a first cover and an second cover and lodges ink ribbon in a folded state; and a driving means to take the ink ribbon into the ink ribbon lodging section, wherein the ink ribbon is taken into from an enter opening of the ink ribbon lodging section and is drawn out from an ejecting opening of the ink ribbon lodging section through the driving means; and an embankment is furnished near to the ejecting opening of the ink ribbon lodging section and has a transverse width that becomes more and more wide towards movement downstream side of the ink ribbon.

Moreover, in the ink ribbon cassette, the embankment may extend from the first cover to the second cover.

Moreover, according to the present invention, there is also provided an ink ribbon cassette, comprising an ink ribbon lodging section that has a first cover and an second cover and lodges ink ribbon in a folded state; and a driving means to take the ink ribbon into the ink ribbon lodging section, wherein the ink ribbon is taken into from an enter opening of the ink ribbon lodging section and is drawn out from an ejecting opening of the ink ribbon lodging section through the driving means; and a dual embankment is furnished on an ink ribbon movement path placed the outside of the ejecting opening of the ink ribbon lodging section, the dual embankment having a rib shape protruding toward an inside direction, at least at either side of the first cover and the second cover.

Moreover, according to the present invention, there is also provided an ink ribbon cassette, comprising an ink ribbon lodging section that has a first cover and an second cover and lodges ink ribbon in a folded state; and a driving means to take the ink ribbon into the ink ribbon lodging section, wherein the ink ribbon is taken into from an enter opening of the ink ribbon lodging section and is drawn out from an ejecting opening of the ink ribbon lodging section through the driving means; and at least a protruding portion is furnished on sidewall of the ink ribbon lodging section.

Moreover, in the ink ribbon cassette, two protruding portions may be respectively furnished near to the entering opening and the ejecting opening of the ink ribbon lodging section.

Further, according to the present invention, there is provided a printing apparatus, comprising an ink ribbon cassette, wherein the ink ribbon cassette includes an ink ribbon lodging section that has a first cover and an second cover and lodges ink ribbon in a folded state; and a driving means to take the ink ribbon into the ink ribbon lodging section, wherein the ink ribbon is taken into from an enter opening of the ink ribbon lodging section and is drawn out from an ejecting opening of the ink ribbon lodging section through the driving means; and an embankment is furnished near to the ejecting opening of the ink ribbon lodging section and has a transverse width that becomes more and more wide towards movement downstream side of the ink ribbon.

Moreover, in the printing apparatus ink ribbon cassette, the embankment may extend from the first cover to the second cover.

Moreover, according to the present invention, there is also provided a printing apparatus, comprising an ink ribbon cassette, wherein the ink ribbon cassette includes an ink ribbon lodging section that has a first cover and an second cover and lodges ink ribbon in a folded state; and a driving means to take the ink ribbon into the ink ribbon lodging section, wherein the ink ribbon is taken into from an enter opening of the ink ribbon lodging section and is drawn out from an ejecting opening of the ink ribbon lodging section through the driving means; and a dual embankment is furnished on an ink ribbon movement path placed the outside of the ejecting opening of the ink ribbon lodging section, the dual embankment having a rib shape protruding toward an inside direction, at least at either side of the first cover and the second cover.

Moreover, according to the present invention, there is also provided a printing apparatus, comprising an ink ribbon cassette, wherein the ink ribbon cassette includes an ink ribbon lodging section that has a first cover and an second cover and lodges ink ribbon in a folded state; and a driving means to take the ink ribbon into the ink ribbon lodging section, wherein the ink ribbon is taken into from an enter opening of the ink ribbon lodging section and is drawn out from an ejecting opening of the ink ribbon lodging section through the driving means; and at least a protruding portion is furnished on sidewall of the ink ribbon lodging section.

Moreover, in the printing apparatus, two protruding portions may be respectively furnished near to the entering opening and the ejecting opening of the ink ribbon lodging section.

### EFFECT OF THE PRESENT INVENTION

According to the ink ribbon cassette and the printing apparatus of the present invention, because provided a lengthways embankment near to an ejecting opening of an ink ribbon lodging section, whose transverse width becomes more and more wide towards movement downstream side, even if in the case that the ink ribbon is extended for prolong the life of the ink ribbon cassette, it is possible to prevent the ink ribbon from getting across the lengthways embankment to cause dual movement.

The above and other objects and features of the present invention will become apparent from the following detailed description and the appended claims with reference to the accompanying drawings.

### BRIEF DESCRIPTION OF THE DRAWINGS

FIG. 1A is a diagram showing a structure of an ink ribbon cassette in embodiment 1 of the present invention and showing a state in that an upper cover is removed;

FIG. 1B is a diagram showing a side of an ink ribbon cassette in embodiment 1 of the present invention;

FIG. 2A is an enlarged diagram showing a detail structure of a lengthways embankment part in embodiment 1 of the present invention;

FIG. 2B is a longitudinal section diagram showing a detail structure of a lengthways embankment part in embodiment 1 of the present invention;

FIG. 3 is a longitudinal section diagram showing a circumference of a guide section in embodiment 1 of the present invention;

FIG. 4 is a diagram showing a summary structure of a printing apparatus in embodiment 1 of the present invention;

FIG. 5 is a cubic diagram showing an external view of a printing apparatus in embodiment 1 of the present invention;

FIG. 6 is a diagram showing an installation structure of an ink ribbon cassette of a cartridge assembly in embodiment 1 of the present invention;

FIG. 7 is a first diagram showing operation of an ink ribbon cassette in embodiment 1 of the present invention;

FIG. 8 is a second diagram showing operation of an ink ribbon cassette in embodiment 1 of the present invention;

FIG. 9 is a third diagram showing operation of an ink ribbon cassette in embodiment 1 of the present invention;

FIG. 10 is a diagram showing a structure of an ink ribbon cassette in embodiment 2 of the present invention;

FIG. 11 is a longitudinal section diagram showing a dual embankment part in embodiment 1 of the present invention;

FIG. 12 is a diagram showing operation of an ink ribbon cassette in embodiment 2 of the present invention;

FIG. 13 is a diagram showing a structure of an ink ribbon cassette in embodiment 3 of the present invention;

FIG. 14 is a diagram showing operation of an ink ribbon cassette in embodiment 3 of the present invention;

FIG. 15 is a diagram showing a structure of a lower cover in embodiment 3 of the present invention;

FIG. 16 is a diagram showing a structure of a conventional ink ribbon cassette;

FIG. 17 is a longitudinal section diagram showing a conventional embankment part; and

FIG. 18 is a diagram showing operation of a conventional ink ribbon cassette.

### DETAILED DESCRIPTION OF THE PREFERRED EMBODIMENTS

Embodiments of the invention will be described in detail hereinbelow with reference to the drawings. In the following embodiments, regarding the same element used in common, the same symbol is assigned.

### Embodiment 1

Structure:

Initially, it is to explain a structure and an external view of a printing apparatus 15 installing an ink ribbon cassette 1 of embodiment 1.

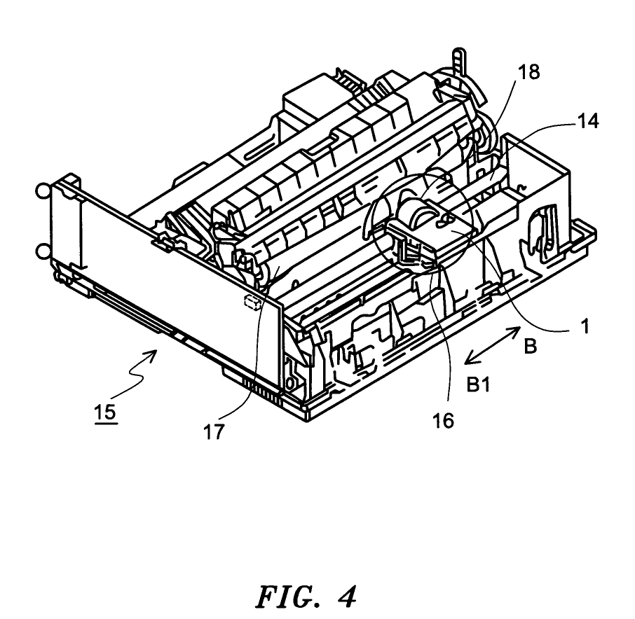

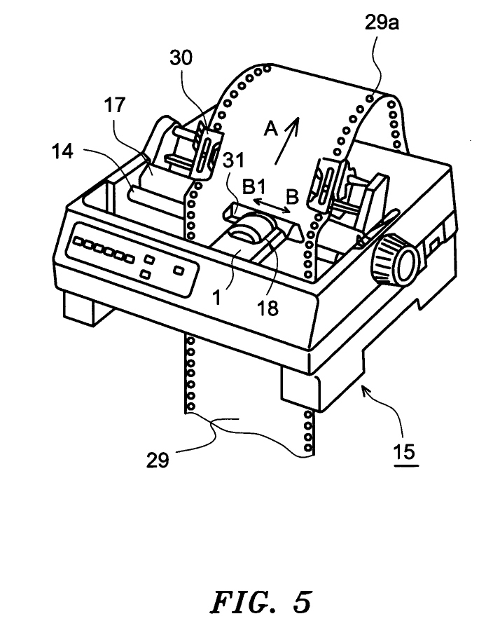

FIG. 4 is a diagram showing a summary structure of a printing apparatus in embodiment 1 of the present invention; and FIG. 5 is a cubic diagram showing an external view of a printing apparatus in embodiment 1 of the present invention.

The printing apparatus shown by the FIGS. 4 and 5 is that of bottom-pull type, which uses a printing head 18 to performs a print while using a pull up tractor 30 to pull up, for example, sprocket paper 29 serving as medium.

As shown by FIG. 4, in a carriage assembly 16, an ink ribbon cassette 1 is installed as holding the printing head 18. A platen 17 and a carriage shaft 14 are installed in parallel. The carriage assembly 16 is slidably installed on the carriage shaft 14, and moves while spacing along an arrow B-B1 direction being a shaft direction of the platen 17 through a drive source (not shown) rotates.

The printing head 18 is driven to correspond to the timing of the spacing operation and is pressed by a ribbon guide 31 as shown FIG. 5, then performs a print with respect to continuous paper medium such as sprocket paper 29 or the like wrapped round the platen 17.

Moreover, on both sides of the sprocket paper 29, sprocket holes 29a are respectively provided along the movement direction of the sprocket paper 29, and fits a post (not shown) furnished on the pull up tractor 30, then moves along an arrow A direction while being fixed.

That is, there is such a structure: the carriage assembly 16 installing the printing head 18 and the ink ribbon cassette 1, while sliding the carriage shaft 14 furnished in parallel with the platen 17, spaces the printing head 18 along the arrow B-B1 direction. To correspond to the timing of the operation, plural wires (not shown) provided inside the ink ribbon cassette 1 are driven along the arrow A direction, and impacted via ink ribbon (not shown) lodged in the ink ribbon cassette 1, then a print is performed with respect to the sprocket paper 29.

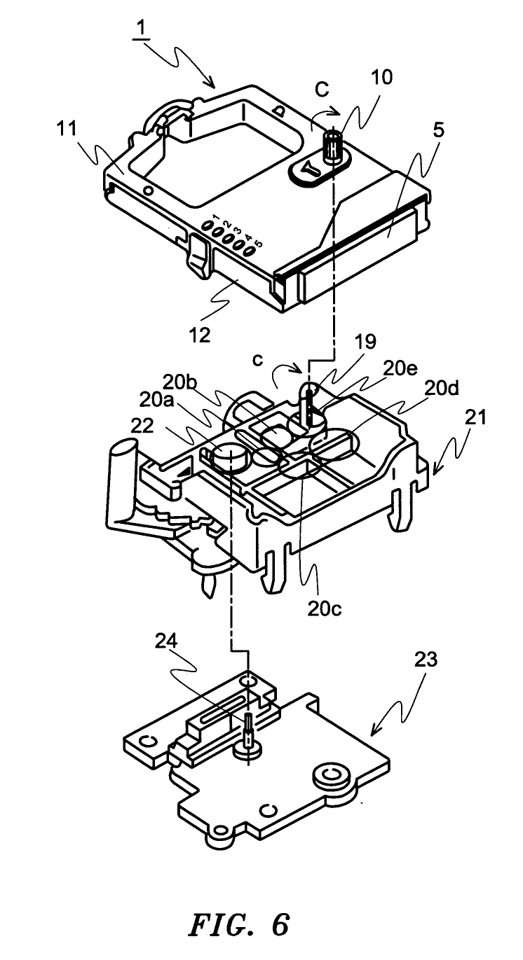

FIG. 6 is a diagram showing an installation structure of an ink ribbon cassette of a cartridge assembly in embodiment 1 of the present invention.

A space motor shaft 24 is installed on a space motor 23, and is connected with a ribbon gear 22 of a ribbon feed gear assembly 21. Then, a power from the space motor 23 is transmitted to a ribbon drive gear 19 via plural gear arrangements 20a˜20e, and the ribbon drive gear 19 is rotated along an arrow C direction.

The ribbon drive gear 19 connects with the drive gear 10 of the ink ribbon cassette 1, and takes in the ink ribbon that is lodged in the ink ribbon cassette 1 and is mentioned below through rotating the drive gear 10 along the arrow C direction. In an ink tank 5, ink is accommodated for providing the ink to the ink ribbon. Then, the ink ribbon cassette 1 includes an upper cover 11 as an upper basket body, and a lower cover 12 as a lower basket body so as to form a structure covering circumference. Moreover, regarding a drive method of the ink ribbon cassette 1, because it is not relative to the present invention, its detail explanation is omitted for simplification.

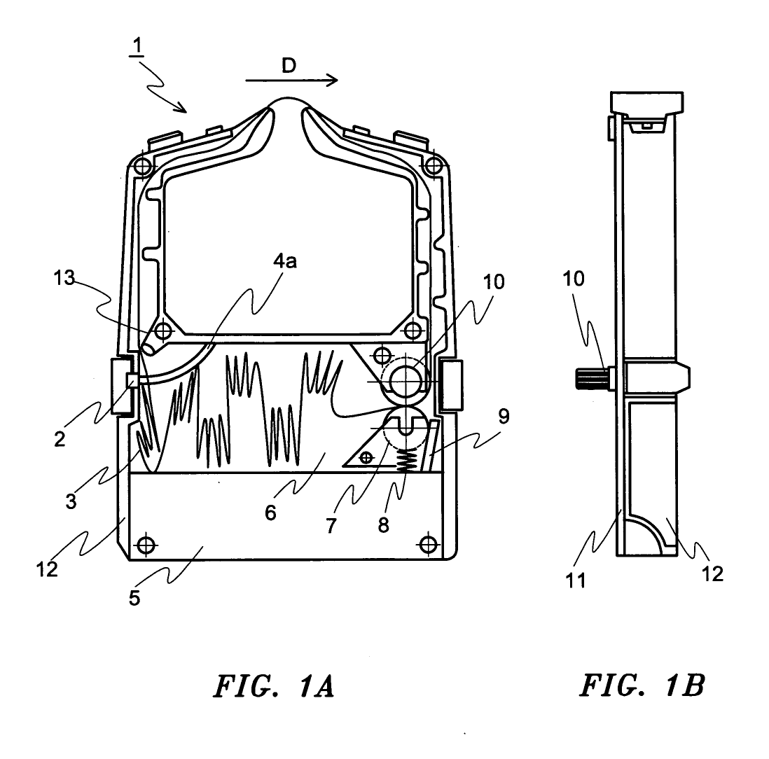

FIG. 1A is a diagram showing a structure of an ink ribbon cassette in embodiment 1 of the present invention and showing a state in that an upper cover is removed; and FIG. 1B is a diagram showing a side of an ink ribbon cassette in embodiment 1 of the present invention.

The ink ribbon cassette 1 shown by FIG. 1A is installed in the printing apparatus 15, its upper cover and its lower cover are formed by the upper cover 11 and the lower cover 12 shown by FIG. 1B.

The ink ribbon cassette 1 includes an ink ribbon 3, an ink ribbon lodging section 6 to lodge the ink ribbon 3 in a folded shape, and an ink tank 5 to accommodate ink.

Near by the entering opening, a drive gear 10 and a transfer gear 7 placed as facing to the drive gear 10 are furnished. Then, the ink ribbon 3 moves along an arrow D direction through the drive gear 10 and the transfer gear 7 sandwich and roll the ink ribbon 3. Further, under the transfer gear 7, a spring 8 is furnished to press the transfer gear 7 against the drive gear 10.

The ink tank 5 supplies the ink accommodated in the inside to the ink ribbon 3 via a wick 9 and the transfer gear 7.

Near by the ejecting opening of the ink ribbon lodging section 6, an embankment 4a and an embankment 4b mentioned below are furnished for preventing the ink ribbon 3 from dashing out. Further, on the inside surface of side wall on the outside of the lower cover 12, a lengthways embankment 2 is furnished for preventing the ink ribbon 3 from happening dual movement (i.e. multiple feeding/dual feeding).

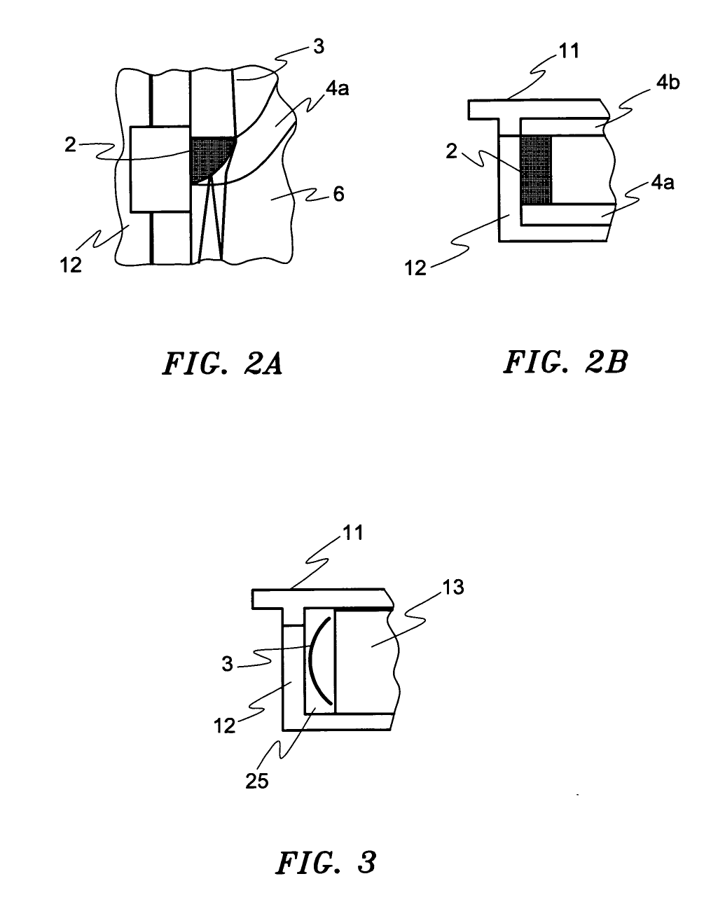

FIG. 2A is an enlarged diagram showing a detail structure of a lengthways embankment part in embodiment 1 of the present invention; and FIG. 2B is a longitudinal section diagram showing a detail structure of a lengthways embankment part in embodiment 1 of the present invention.

The lengthways embankment 2 is furnished on the lower side wall of cover near to the ejecting opening of the ink ribbon lodging section 6 so as to make an interval making the ink ribbon 3 pass become more and more narrow towards movement downstream side of the ink ribbon 3 and to uniformly extend from the embankment 4a of the lower cover 12 to the embankment 4b of the upper cover 11.

Moreover, regarding the shape of the lengthways embankment 2, it may be set into that capable of making the ink ribbon 3 pass become more and more narrow towards movement downstream side of the ink ribbon 3, it also may be set into that of convex type or the like.

FIG. 3 is a longitudinal section diagram showing a circumference of a guide section in embodiment 1 of the present invention.

As shown by FIG. 3, because the inside surface of the side wall of the lower cover 12 and a guide section 13 makes the width of an ink ribbon movement path 25 become narrow, that is, the width makes the ink ribbon 3 be pressed from upside and underside in an arc shape by the embankment 4a and the embankment 4b so that only the ink ribbon 3 passes, even if the back part of the ink ribbon 3 outstrips the front part of the ink ribbon 3, it is possible to prevent the back part of the ink ribbon 3 from entering.

Operation:

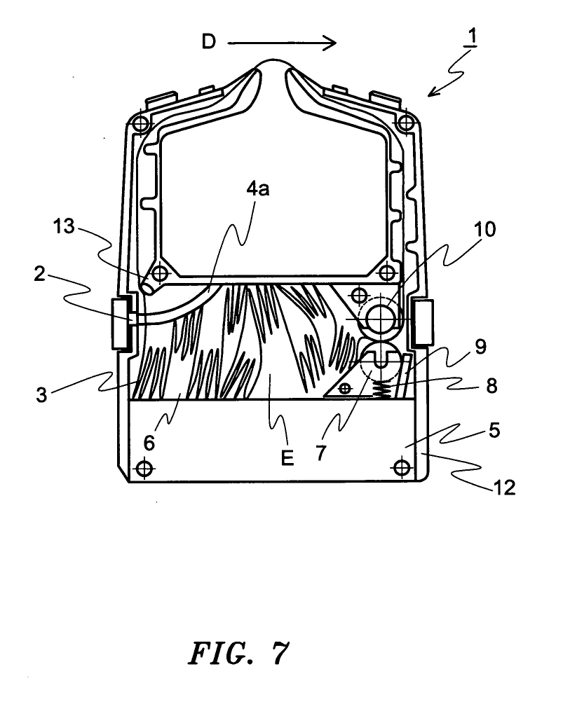

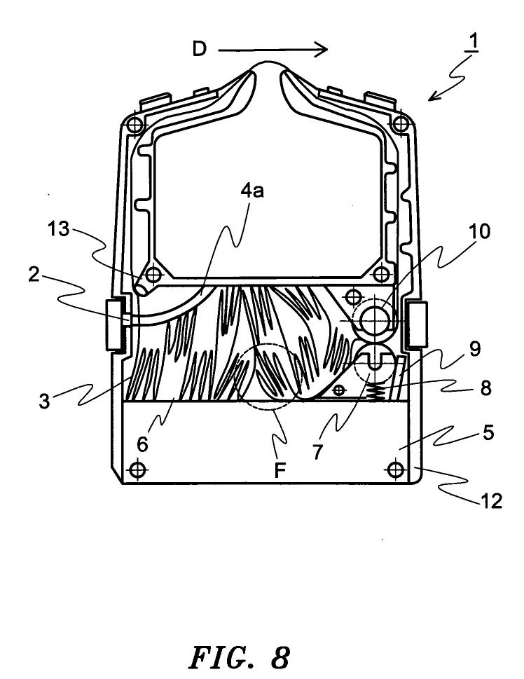

According to the above-stated structure, the ink ribbon cassette and the printing apparatus of the embodiment 1 performs the following operation. Next is to explain the operation by using FIGS. 7˜9.

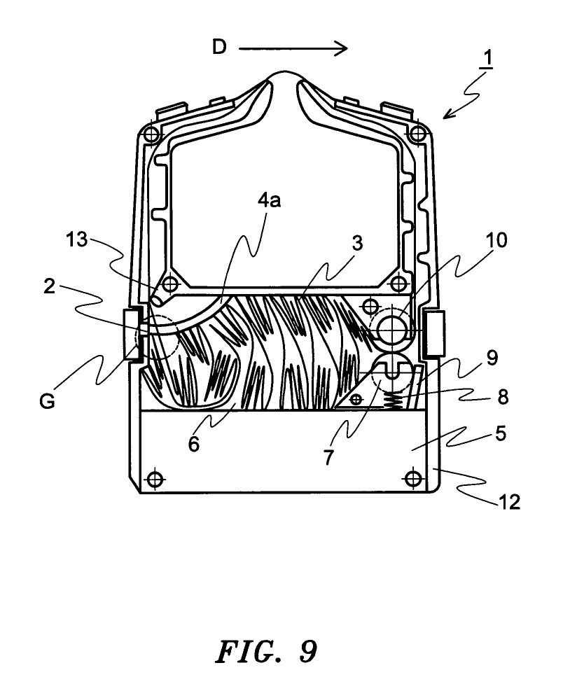

FIG. 7 is a first diagram showing operation of an ink ribbon cassette in embodiment 1 of the present invention; FIG. 8 is a second diagram showing operation of an ink ribbon cassette in embodiment 1 of the present invention; FIG. 9 is a third diagram showing operation of an ink ribbon cassette in embodiment 1 of the present invention.

Initially, as shown by FIG. 7, the ink ribbon 3 is nipped by the drive gear 10 and the transfer gear 7, and is taken into the ink ribbon lodging section 6. Then the ink ribbon 3 is lodged into the ink ribbon lodging section 6 in a folded state.

However, in the ink ribbon lodging section 6, space E happens and force acts on the ink ribbon 3 to push out the ink ribbon 3 toward the ejecting opening, as shown by a broken line part F in FIG. 8, the back part of the ink ribbon 3 outstrips the front part of the ink ribbon 3 and enters the space E, in such a state, the ink ribbon 3 is conveyed to the ejecting opening.

At that time, though the ink ribbon 3 shown by the broken line part F and conveyed to the ejecting opening has a tendency to be drawn out in company with the front part of the ink ribbon 3 that has drawn out due to a friction between the front and the back parts, as shown by a broken line part G in FIG. 9, because the foreside of the back part of the ink ribbon 3 comes into contact with the lengthways embankment 2, and the ink ribbon 3 is not caught since the inclination of the lengthways embankment 2, the ink ribbon 3 does not get over the embankment 4a and the embankment 4b so that there is no dual movement.

Further, because the lower cover 12 and a guide section 13 makes the width of the ink ribbon movement path 25 become narrow so that the ink ribbon 3 is pressed from upside and underside in an arc shape by the embankment 4a and the embankment 4b and only the ink ribbon 3 can passes, it is possible to more prevent the ink ribbon 3 from happening dual movement.

### Effect of the Embodiment 1

As stated in detail above, according to the ink ribbon cassette and the printing apparatus in the embodiment 1, because provided a lengthways embankment near to the an ejecting opening of an ink ribbon lodging section, whose transverse width becomes more and more wide towards movement downstream side, even if in the case that the ink ribbon is extended for prolong the life of the ink ribbon cassette, it is possible to prevent the ink ribbon from getting across the lengthways embankment to cause dual movement.

### Embodiment 2

Structure:

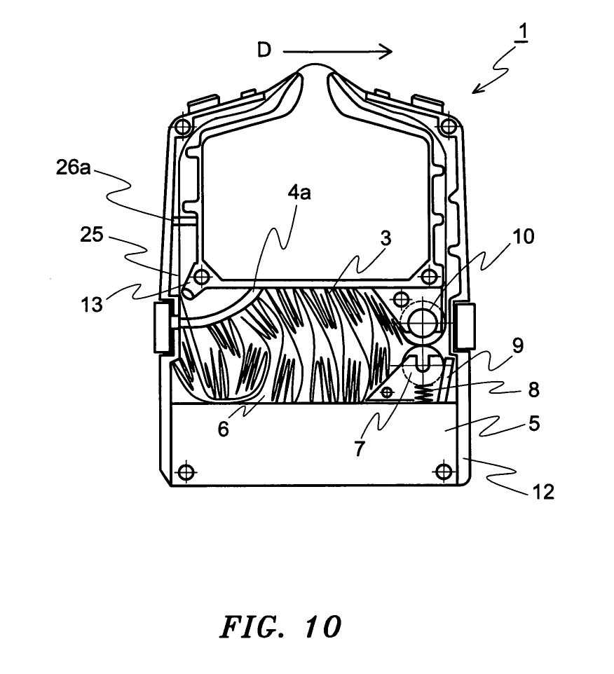

FIG. 10 is a diagram showing a structure of an ink ribbon cassette in embodiment 2 of the present invention.

As shown by FIG. 10, an ink ribbon cassette and a printing apparatus of the embodiment 2 respectively have a dual embankment 26a and a dual embankment 26b that are furnished on the ink ribbon movement path 25 of downstream side of an ink ribbon lodging section

FIG. 11 is a longitudinal section diagram showing a dual embankment part in embodiment 1 of the present invention.

The dual embankment 26b and the dual embankment 26a are respectively furnished on the upper cover 11 and the lower cover 12 in a protruding state, the shape of the dual embankment 26a or the dual embankment 26b is a rib shape.

Because the ink ribbon 3 to pass between the dual embankment 26a and the dual embankment 26b expands along a transverse direction of the ink ribbon movement path 25, even if the ink ribbon 3 happened dual movement, it is possible to prevent the foreside of the ink ribbon 3 from passing between the dual embankment 26a and the dual embankment 26b.

Further, because the height of the dual embankment 26a and the dual embankment 26b is higher than that of the embankment 4a and the embankment 4b, it is possible to certainly prevent an actual dual movement. Regarding other compositions, because they are the same as that in embodiment 1, their explanations are omitted for simplification.

Operation:

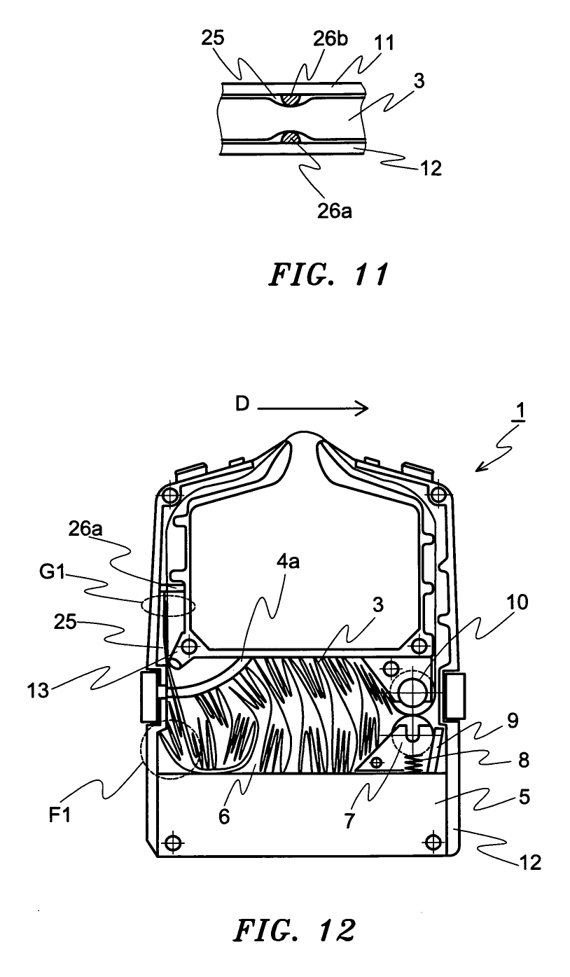

According to the above-stated structure, the ink ribbon cassette and the printing apparatus of the embodiment 2 performs the following operation. Next is to explain the operation by using FIG. 12.

FIG. 12 is a diagram showing operation of an ink ribbon cassette in embodiment 2 of the present invention.

It is the same as the embodiment 1 that the ink ribbon 3 is nipped by the drive gear 10 and the transfer gear 7, and is taken into the ink ribbon lodging section 6, then the ink ribbon 3 is lodged into the ink ribbon lodging section 6 in a folded state.

Further, as shown by a broken line part F1 on the left side of the ink ribbon 3 in FIG. 12, when the back part of the ink ribbon 3 which has outstripped the front part of the ink ribbon 3 comes, because of a friction between the front part and the back part, the back part of the ink ribbon 3 gets over the embankment 4a and the embankment 4b and is drawn out in company with the front part of the ink ribbon 3.

When the foreside of the ink ribbon 3 having happened dual movement comes to a position shown by a broken line part G1, the foreside of the ink ribbon 3 having happening dual movement hits the dual embankment 26a and the dual embankment 26b expanding along a lengthways direction of the ink ribbon movement path 25, and is stopped to get across the dual embankment 26a and the dual embankment 26b.

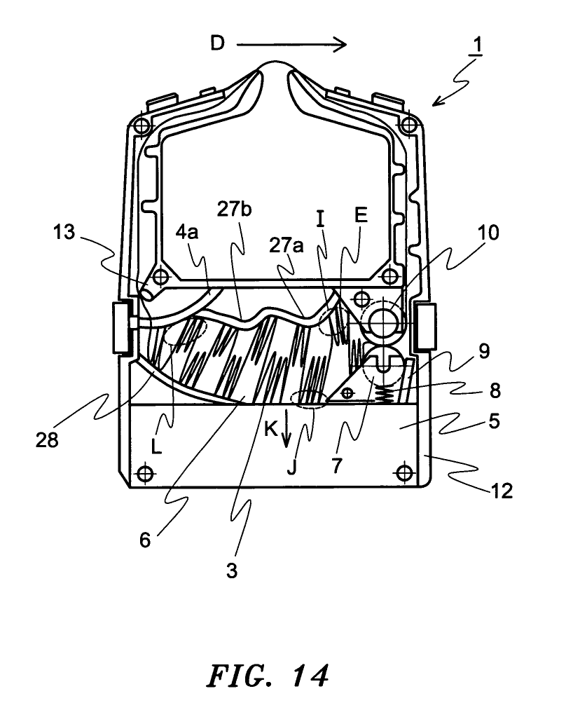

Further, because the height of the dual embankment 26a and the dual embankment 26b is higher than that of the embankment 4a and the embankment 4b shown by FIG. 14, it is possible to certainly prevent an actual dual movement. Moreover, because the ink ribbon 3 is little near to the dual embankment 26a and the dual embankment 26b, the dual embankment 26a and the dual embankment 26b would not become a movement load of the ink ribbon 3.

Furthermore, in the description stated above, though only explained to provide the dual embankment 26a and the dual embankment 26b, it is possible to only provide either of the dual embankment 26a and the dual embankment 26b.

### Effect of the Embodiment 2

As stated in detail above, according to the ink ribbon cassette and the printing apparatus in the embodiment 2, because provided dual embankments on ink ribbon movement path on the downstream side of the ink ribbon lodging section, as respectively protruding from the lower cover and the upper cover, similarly to the embodiment 1, even if in the case that the ink ribbon is extended for prolong the life of the ink ribbon cassette, it is possible to prevent the ink ribbon from getting across the lengthways embankment to cause dual movement.

### Embodiment 3

Structure:

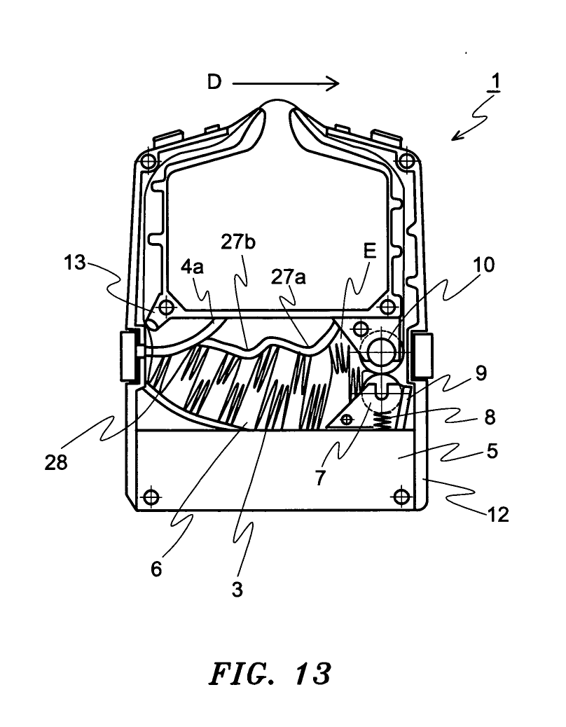

FIG. 13 is a diagram showing a structure of an ink ribbon cassette in embodiment 3 of the present invention.

As shown by FIG. 13, an ink ribbon cassette and a printing apparatus of the embodiment 3 respectively have a protruding portion 27a serving as a first protruding portion and a protruding portion 27b serving as a second protruding portion, that are provided in the ink ribbon lodging section 6. The protruding portion 27a and the protruding portion 27b respectively are a part of the lower cover 12, and respectively are furnished near to entering opening and the ejecting opening of the ink ribbon lodging section 6.

The protruding portion 27a makes the ink ribbon 3 be pressed and contact with it along its shape; the protruding portion 27b has a weaker embankment action to lighten the density of the ink ribbon 3 pressed into the ejecting opening of the ink ribbon lodging section 6. Then, in order to easily lead the ink ribbon 3 to the ejecting opening of the ink ribbon lodging section 6, as shown by FIG. 13, it is better to furnish a bending portion 28.

Regarding other compositions, because they are the same as that in embodiments 1 and 2, their explanations are omitted for simplification.

Operation:

According to the above-stated structure, the ink ribbon cassette and the printing apparatus of the embodiment 3 performs the following operation. Next is to explain the operation by using FIG. 14.

FIG. 14 is a diagram showing operation of an ink ribbon cassette in embodiment 3 of the present invention

It is the same as the embodiments 1 and 2 that the ink ribbon 3 is nipped by the drive gear 10 and the transfer gear 7, and is taken into the ink ribbon lodging section 6, then the ink ribbon 3 is lodged into the ink ribbon lodging section 6 in a folded state.

When the ink ribbon 3 is taken into the space E of the ink ribbon lodging section 6 by the drive gear 10, as shown by FIG. 14, because the ink ribbon 3 is pressed along the shape of the protruding portion 27a and contacts with the protruding portion 27a in a position shown by a broken line part I, the ink ribbon 3 does not exist to further enter the space E.

Further, because the ink ribbon 3 is pressed along an arrow K direction on the opposite side of the protruding portion 27a, the ink ribbon 3 contacts with a position shown by a broken line part J, and does not exist to further enter. Thus, the ink ribbon 3 is sequentially lodged into the ink ribbon lodging section 6, so it becomes little that the back part of the ink ribbon 3 outstrips the front part of the ink ribbon 3 and is folded.

Furthermore, the protruding portion 27b has a weaker embankment action to lighten the density of the ink ribbon 3 pressed into a position of a broken line part L, so the ink ribbon 3 smoothly moves to the ejecting opening of the ink ribbon lodging section 6 through the bending portion 28.

According to the structure stated above, because the density of the ink ribbon 3 is adjusted toward the side of the embankment 4a and the embankment 4b from the side of the drive gear 10, the density of the ink ribbon 3 does not become high in circumference of the embankment 4a and the embankment 4b. Therefore, it is possible to reduce friction while drawing out the ink ribbon 3.

Moreover, in the description stated above, though only explained to provide the protruding portion 27a and the protruding portion 27b, i.e. two protruding portions, it is possible to provide more protruding portions or only one protruding portion.

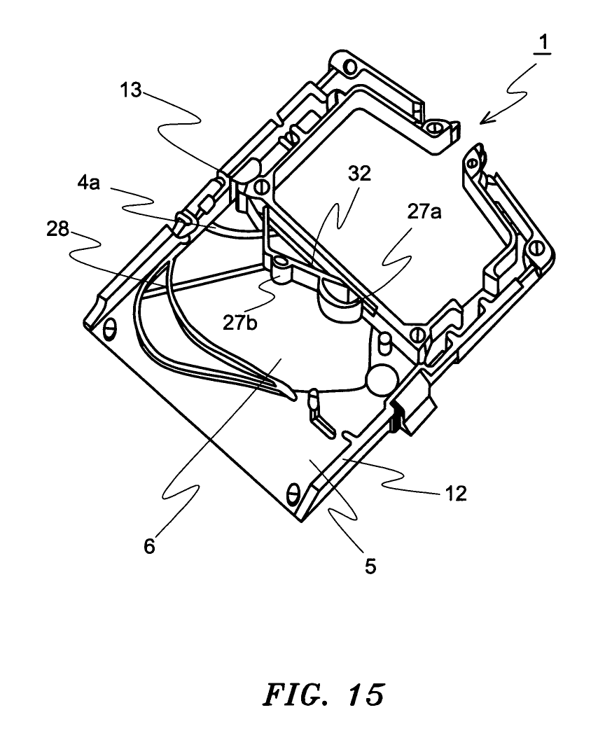

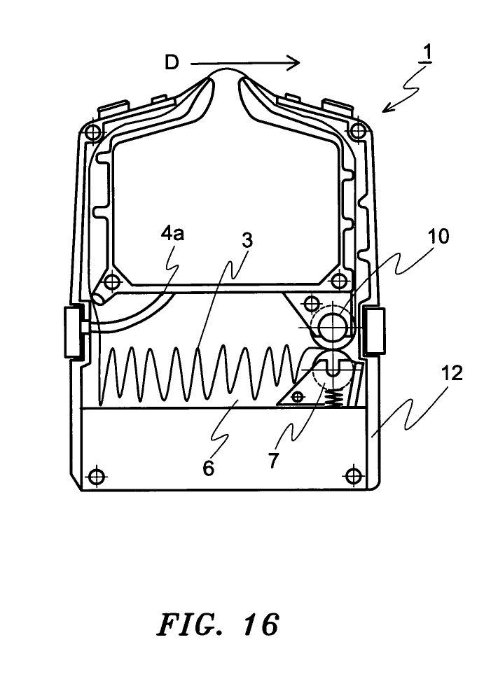

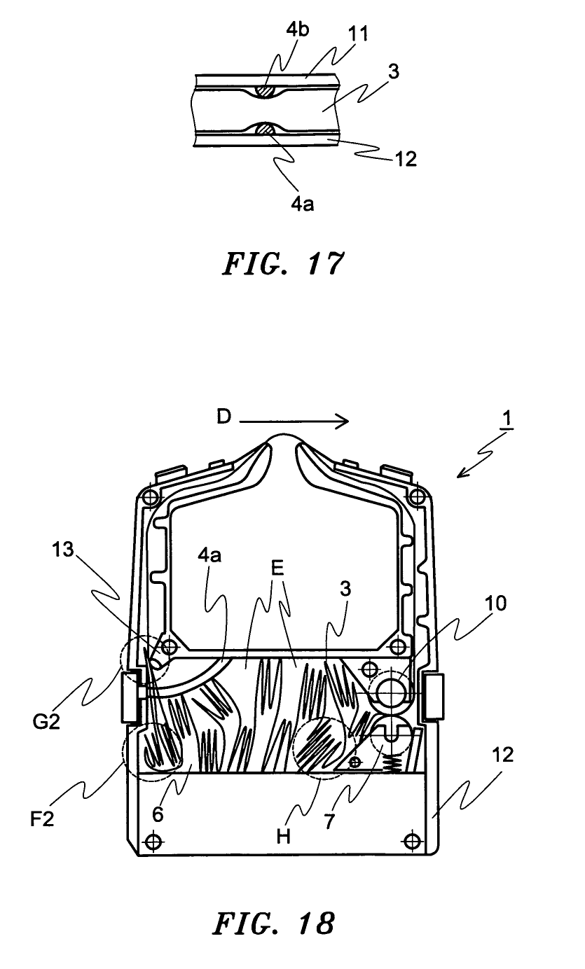

FIG. 15 is a diagram showing a structure of a lower cover in embodiment 3 of the present invention.

As shown by FIG. 15, it is possible to furnish a rib 32 in the ink ribbon lodging section 6, and to furnish the protruding portion 27a and the protruding portion 27b on the rib 32 respectively near to the entering opening and the ejecting opening of the ink ribbon lodging section 6.

### Effect of the Embodiment 3

As stated in detail above, according to the ink ribbon cassette and the printing apparatus in the embodiment 3, because provided the first protruding portion in the space near to the entering opening of the ink ribbon lodging section, it becomes little that the back part of the ink ribbon 3 outstrips the front part of the ink ribbon 3 to be folded. Furthermore, because provided the second protruding portion near to the ejecting opening of the ink ribbon lodging section, it is possible to inhibit the density of the ink ribbon near to the ejecting opening of the ink ribbon lodging section so as to reduce friction while drawing out the ink ribbon. As a result, even if in the case that the ink ribbon is extended for prolong the life of the ink ribbon cassette, it is possible to prevent the ink ribbon from getting across the lengthways embankment to cause dual movement.

### Transformation Example

In the embodiments 1 and 2, a structure is explained in which a bending portion 28 is not furnished in the ink ribbon lodging section 6. However, the bending portion 28 may be furnished as the embodiment 3. Thus, it is possible to further smoothly move the ink ribbon 3 to the ejecting opening of the ink ribbon lodging section 6.

### The Utilization Possibility in Industry:

Not only the present invention can be applied to the above stated case, but also the present invention can be applied to various printing apparatus using the ink ribbon cassette.

The present invention is not limited to the foregoing embodiments but many modifications and variations are possible within the spirit and scope of the appended claims of the invention.

What is claimed is:

1. An ink ribbon cassette, comprising:
an ink ribbon lodging section that has a first cover and an second cover and lodges ink ribbon in a folded state; and
a driving means to take the ink ribbon into the ink ribbon lodging section,
wherein the ink ribbon is taken into from an enter opening of the ink ribbon lodging section and is drawn out from an ejecting opening of the ink ribbon lodging section through the driving means; and an embankment is furnished near to the ejecting opening of the ink ribbon lodging section and has a transverse width that becomes more and more wide towards movement downstream side of the ink ribbon.

2. The ink ribbon cassette according to claim 1,
wherein the embankment extends from the first cover to the second cover.

3. An ink ribbon cassette, comprising:
an ink ribbon lodging section that has a first cover and an second cover and lodges ink ribbon in a folded state; and
a driving means to take the ink ribbon into the ink ribbon lodging section,
wherein the ink ribbon is taken into from an enter opening of the ink ribbon lodging section and is drawn out from an ejecting opening of the ink ribbon lodging section through the driving means; and a dual embankment is furnished on an ink ribbon movement path placed the outside of the ejecting opening of the ink ribbon lodging section, the dual embankment having a rib shape protruding toward an inside direction, at least at either side of the first cover and the second cover.

4. An ink ribbon cassette, comprising:
an ink ribbon lodging section that has a first cover and an second cover and lodges ink ribbon in a folded state; and
a driving means to take the ink ribbon into the ink ribbon lodging section,
wherein the ink ribbon is taken into from an enter opening of the ink ribbon lodging section and is drawn out from an ejecting opening of the ink ribbon lodging section through the driving means; and at least a protruding portion is furnished on sidewall of the ink ribbon lodging section.

5. The ink ribbon cassette according to claim 4,
wherein two protruding portions are respectively furnished near to the entering opening and the ejecting opening of the ink ribbon lodging section.

6. A printing apparatus, comprising:
an ink ribbon cassette,
wherein the ink ribbon cassette includes:
an ink ribbon lodging section that has a first cover and an second cover and lodges ink ribbon in a folded state; and
a driving means to take the ink ribbon into the ink ribbon lodging section,
wherein the ink ribbon is taken into from an enter opening of the ink ribbon lodging section and is drawn out from an ejecting opening of the ink ribbon lodging section through the driving means; and an embankment is furnished near to the ejecting opening of the ink ribbon lodging section and has a transverse width that becomes more and more wide towards movement downstream side of the ink ribbon.

7. The printing apparatus ink ribbon cassette according to claim 6,
wherein the embankment extends from the first cover to the second cover.

8. A printing apparatus, comprising:
an ink ribbon cassette,
wherein the ink ribbon cassette includes:
an ink ribbon lodging section that has a first cover and an second cover and lodges ink ribbon in a folded state; and
a driving means to take the ink ribbon into the ink ribbon lodging section,
wherein the ink ribbon is taken into from an enter opening of the ink ribbon lodging section and is drawn out from an ejecting opening of the ink ribbon lodging section through the driving means; and a dual embankment is furnished on an ink ribbon movement path placed the outside of the ejecting opening of the ink ribbon lodging section, the dual embankment having a rib shape protruding toward an inside direction, at least at either side of the first cover and the second cover.

9. A printing apparatus, comprising:
an ink ribbon cassette,
wherein the ink ribbon cassette includes:
an ink ribbon lodging section that has a first cover and an second cover and lodges ink ribbon in a folded state; and
a driving means to take the ink ribbon into the ink ribbon lodging section,
wherein the ink ribbon is taken into from an enter opening of the ink ribbon lodging section and is drawn out from an ejecting opening of the ink ribbon lodging section through the driving means; and at least a protruding portion is furnished on sidewall of the ink ribbon lodging section.

10. The printing apparatus according to claim 9,
wherein two protruding portions are respectively furnished near to the entering opening and the ejecting opening of the ink ribbon lodging section.
